(19) United States
(12) Patent Application Publication
(10) Pub. No.: US 2007/0166047 A1
(43) Pub. Date: Jul. 19, 2007

(54) OPTO-ELECTRIC PHASE-LOCKED LOOP FOR RECOVERING THE CLOCK SIGNAL IN A DIGITAL OPTICAL TRANSMISSION SYSTEM

(76) Inventors: JOERN BERGER, FALKENSEE (DE); CHRISTOF BOERNER, WOLFSBURG (DE); CARSTEN SCHMIDT-LANGHORST, BERLIN (DE)

Correspondence Address: LAW OFFICES OF KARL HORMANN, 86 SPARKS STREET, CAMBRIDGE, MA, 02138, US

(21) Appl. No.: 10/547,608

(22) PCT Filed: Feb. 25, 2004
(86) PCT No.: PCT/DE04/00340

§ 371 Date: Jun. 5, 2006

(30) Foreign Application Priority Data
Feb. 28, 2003 (DE) 103 10 015.6

(51) Int. Cl. H04B 10/00

(52) U.S. Cl. 398/155

(57) ABSTRACT

A phase-locked loop for a differential recovery of the clock signal wherein an extracted data signal (DS) is conveyed via a phase delay element and thence to a phase comparator. In the phase comparator comparison signals, whose phase shifts can be set relative to one another, differential phase evaluation is carried out. This results in a control signal (RS) whose operating point, independent of the power of the transmit channel, always lies in the center of the control range. In the inventive differential timing recovery, the dependencies on power fluctuations, signal-to-noise ratio, the pulse shape and on transmitted bit patterns are eliminated to the greatest possible extent.

### BACKGROUND OF THE INVENTION

1. Field of the Invention

The invention relates to an opto-electric phase-locked loop for recovering, at a receiver, the clock signal of a high frequency return-to-zero data signal transmitted in a digital optical transmission system, with an optically switching phase comparator, an electronic differential amplifier and a voltage-controlled oscillator, whereby a comparison signal formed by the phase comparator by comparison of the data signal with the recovered clock signal is fed, together with a signal extracted from the data signal, by way of opto-electric transducers, to the two inputs of the differential amplifier, and the electric control signal formed at the output of the differential amplifier is fed by way of a low-pass filter to the oscillator the adjusted frequency signal of which is issued as the recovered clock signal.

2. The Prior Art

The recovery of the clock signal (clock recovery) at the receiver of a digital optical transmission system is an essential function, for instance, in optical receivers, optical regenerators or in time-dependent multiplexers with add-drop-functions as well as in measuring systems incorporating a sampling oscilloscope, for instance. The goal of recovering the clock signal is to produce at the receiver a clock pulse of substantially the same frequency and phase (or a whole-number multiple or fractions thereof) as the transmitted data signal so that only the data signal need be transmitted and no channel is needed for the clock pulse of the data signal. This brings up the problem of compensating frequency fluctuations and phase differences caused by varying ambient temperatures, different components and aging of the transmitter and receiver and of maintaining in phase the recovered data clock pulse and the data signal. At present, two developmental approaches are being pursued for recovering the clock pulse from a high bit rate return-to-zero data signal (return to zero RZ) as occur when transmitting optical data signals by time multiplexing (optical time division multiplexing—OTDM). On the one hand, for recovery of the clock pulse, the data signal may be fed directly to an optical oscillator (for instance by a mode-coupled or self-pulsing laser), and on the other hand the received data signal may be fed into an opto-electric phase-locked loop (PLL) by a phase comparator. The phase comparator is electrically or optically controlled by a frequency signal (recovered clock pulse) generated by a voltage-controlled oscillator (VCO) and it compares the frequency signal with the received data signal. The phase difference is in turn fed as an electric control signal to the oscillator. Closing the phase-locked loop on the clock pulse of the received data signal ensures a substantially stable clock pulse recovery.

In a phase-locked loop, the control action can be described with reference to the control curve (represented by the switching window of the phase comparator). In its locked or latched state, the phase-locked loop seeks to maintain a point on the control curve (the operating point). Since a substantially linear connection between phase and control signal is required for the control of the phase-locked loop, the edges of the switching window provide an ideal control range. Advantageously, the operating point is placed into the center of the control range. For this purpose, a balancing signal is subtracted from the control curve. In conventional phase-locked loops the balancing signal to be subtracted is at best derived from the data signal by a branch ahead of the phase comparator. However, this method yields but an unsatisfactory independence from power fluctuations. The disadvantage of this approach is that in case of subharmonic clock signal recovery, the control signal is derived only from a periodically recurring section of the data signal, whereas the balancing signal to be subtracted represents the mean power of the data signal. Power fluctuations in periodically recurring individual sections of the data signal (for instance as a result of changes in the bit-pattern ratio or as a result of instabilities in the optical multiplexer) result in shifts of the operating point and, hence, in shifts in the phase position of the recovered clock signal. Furthermore, the operating point is located in a range of signal-to-noise ratio which is inferior to an operating point located at the peak of the switching window.

The relevant prior art upon which the instant invention is based, is Disclosure I by T. Yamamoto et al. “Clock recovery from 160 Gbit/s data signals using phase-locked loop with interferometric optical switch based on semiconductor optical amplifier” (Electronics Letters, 2001, Vol. 37, No. 8, pp. 509-510). The opto-electric phase-locked loop therein disclosed is used for the subharmonic clock signal recovery or a clock signal of 10 GHZ from an RZ data signal embracing 160 Gbit/s. The latter is fed to a phase comparator of SLALOM configuration (Semiconductor Laser Amplifier in a Loop Mirror-SLALOM). In the phase comparator, the fed-in data signal is compared to the recovered clock signal to provide a comparison signal. For this purpose, the data signal is put through and blocked at the pulse rate of the subharmonic clock signal. In addition, in the known phase-locked loop the high-rate data signal is passed by the phase comparator as an output signal. Following the electro-optical transformation in slow photo diodes, the comparison signal and the output signal are fed to an electronic differential amplifier. The electric control signal formed therein is fed to a voltage-controlled oscillator by way of a low-pass filter. The adjustment of the oscillator by the control signal results in recovery of the clock signal. This is made available as an electrical signal and, following an electro-optical transformation, is added to the phase comparator. Accordingly, the clock signal recovery does not attain optimum stability in the locked mode and displays a significant time jitter of the phase position. Furthermore, problems arise in consequence of power fluctuations of the transmitted data signal, fluctuations in the bit pattern and in the signal-to-noise-ratio.

Furthermore, it is known from publication II by D. T. K. Tong et al. “160 Gbit/s clock recovery using electroabsorption modular-based phase-locked loop” (Electronics Letters, 2000, Vol. 36, No. 23, pp. 1951 to 192) for the clock pulse recovery to use an electro-absorption modulator (Electro-absorption Modulator EAM) as a pre-scaler in a phase-locked loop. Because of their low dependence upon polarization, their good extinction ratio, their simple operation and their high integration capability, electro-absorption modulators are highly promising optical components for the processing of high-rate optical data signals. The mentioned publication 11 describes the serial connection of two electro-absorption modulators as pre-scalers for attaining a switching window as narrow as possible.

### OBJECTS OF THE INVENTION

Based upon the closest prior art, the object of the present invention is to be seen in further to develop a phase-locked loop of the kind referred to supra so that precise recovery of the clock signal from high-rate clocked data signals with as low a time jitter of the phase position as possible can be achieved and an optimum latching stability of the phase-locked loop is attained. This is to be accomplished for as large a substantially linear control range and as wide a dynamic range of the data signal as possible. The components used in the phase-locked loop are to be as simple and, therefore, cost-efficient, as possible, yet substantially immune from different interfering fluctuations of any kind, particularly in the transmitted data signal.

### BRIEF SUMMARY OF THE INVENTION

In accordance with the invention, the object in respect of the opto-electric phase-locked loop whose optical comparison signal is fed to a differential amplifier together with an output signal derived from the high-rate clocked optical data signal, is characterized by, prior to the one or the additional phase comparator, the extracted signal is fed to an optical phase delay element and then through the one or through the additional phase comparator where it is superimposed by the recovered and fed-back clock signal and by the two phase-shifted comparison signals formed in the one or more phase comparators being fed to the two inputs of the differential amplifier. Advantageous embodiments of the invention may be gleaned from the sub-claims and will hereafter be described in greater detail in connection with the invention.

The present invention proceeds from the basic assumption that the disadvantages referred to above may be avoided by controlling the phase-locked loop by a signal which corresponds to the first derivative of (phase-based or time-based differentiation) the control curve. The peak of a switching window then becomes the zero-crossing point of the differential control curve. If the operating point is placed into this zero-crossing point it will be optimally positioned in the center of the new control range independent of the instantaneous power in any given data channel. Instead of a genuine mathematical differentiation it is, however, only possible to perform a discrete differentiation (without normalizing). In accordance with the invention, this is accomplished by generating two control curves which are displaced relative to each other and which after differentiation result in the differential control curve. It is thus possible with the phase-locked loop in accordance with the invention in a stable manner to extract the clock signal even from very high data signal rates, for instance, 160 Gbit/s, for further signal processing. Low or higher data rates can also be processed by the phase-locked loop of the invention in part by insertion of corresponding dividing or multiplying operator elements at the output of the voltage controlled oscillator. During transition to lower data rates it is advantageous that there is no need for renewed tuning of the phase delay component ahead of the phase comparator. However, the major interest resides in high and ultra-high data signal rates of 160 Gbit/s and above. In view of the fact that narrower switching windows are required, it is more difficult to extract the clock signal from such signal rates with the known phase-locked loops. Usually, these switching windows result in lower switching contrast and, therefore, to worse signal-to-noise-ratio. In accordance with the invention these disadvantages are substantially compensated even at very high data rates, and high locking stability is achieved by the possibility of simple balancing and manipulation. Further advantageous characteristics of the claimed circuit arrangement which contribute to accomplishing the object will be described in greater detail with reference to appropriate diagrams in the specific description.

In the context of the invention, it is essential that two phase-shifted comparison signals (phase curves) are generated. The phase delay between the two phase curves must be optimized with respect to the stability of the phase-locked loop. The shorter the delay of the two phase curves relative to each other, the more will the (discrete) differentiated phase curve correspond to a genuine differentiation. This ensures control by the phase-locked loop within the maximum switching window at a good signal-to-noise-ratio. As a result of the absence of normalization (division by Δt) the derived differential control signal is relatively weak, however. This circumstance may, however, be compensated by subsequent electrical amplification. Where the delay corresponds to half the period of the data signal, the amplitude of the differential control signal will be at a maximum. However, in that case the signal-to-noise-ratio will not be at its best. Moreover, such a delay will result in a non-linear control range in the differential control curve if the switching window is shorter than half the data signal period. The optimum delay depends upon the data signal rate and the width of the switching window which is in turn dependent upon the phase comparator used and upon its control. Once an acceptable delay has been found for the highest data signal rate, the clock pulse recovery functions as well as or better than at lower data signal rates without any need for changing the delay. As regards the highest data signal rate which can be processed by the phase-locked loop in accordance with the invention, the optimum delay is in the range of about ⅙ to ½ of the data signal period, provided, however, the switching window is not shorter than the delay.

In accordance with the invention, the two comparison signals may be generated in different ways. Basically, one may proceed from two physically different ways or from a common way for the two signals. The simplest solution which in terms of components used is, however, relatively complex is to use two separate phase comparators with the phase delay element being integrated in the input line of one of the two phase comparators (generation of a chronological phase shift in the data signal or output signal path). The use of a common phase comparator for generating the two comparison signals is more sophisticated and more cost-efficient. In the case of bidirectional propagation of the two comparison signals through the phase comparator the data signal is divided into two (physical) paths and delayed by one of the paths (optical paths of different lengths). In the case of unidirectional propagation through the phase comparator the two divided data signals, prior to the delay, are rendered distinct from each other by different polarizations (two independent polarization planes disposed normal to each other). Following their propagation through the phase comparator, the difference between them is detected by a polarization beam splitter or joiner. In unidirectional operation, the delay may be brought about by means of a birefringent fiber or by two polarization beam splitters or joiners provided with an optical connector for each direction of polarization and an optical delay in a connecting path. To make the two signals based upon the received data signal available at the input of the phase-locked loop, the output signal may in one embodiment of the invention be derived from the data signal by way of an optical coupler and, more particularly, a 3 dB coupler. The use of a 3 dB coupler ensures a uniform division of the signal power to the two signal paths. The reduction in power per signal path may be compensated by appropriate amplifier elements in the phase-locked loop. In this manner, the power between the two comparison signals may be distributed in other ways, albeit only to the extent balancing is still possible and sensible.

An essential element of the particularly stable phase-locked loop in accordance with the invention is the preferably one implemented phase comparator which may be operated bidirectionally or unidirectionally and which may be structured in different ways. In general, it is possible, for instance, to use a semiconductor optical amplifier (SOA), an asymmetric demultiplexer in the THz range (TOAD), a symmetric Mach-Zehnder interferometer (SMZI), an ultra-fast nonlinear interferometer (UNI) or a nonlinear optical fiber loop mirror (NOLM) as the phase comparator. According to a further embodiment of the phase-locked loop in accordance with the invention it is particularly advantageous, however, to structure the phase comparator as an electrically controlled electro-absorption modulator. This would make it possible to incorporate the advantages described above in connection with the electro-absorption modulator as an ultra-fast switch. Signal input may take place by one circulator (unidirectional operation) or by two circulators (bidirectional operation). In accordance with a further embodiment of the invention, 3 dB couplers may be used instead of circulators. This would allow integration of the phase-locked loop into a planar hybrid structure or into an integrated optical circuit.

From publication III by I. D. Phillips et al.: “Simultaneous demultiplexing and clock recovery using a single electroabsorption modulator in a novel bi-directional configuration” (Optics Communications 150 (1998), PP. 101-105, an opto-electrical phase-locked loop is known for clock recovery which is provided with a bidirectional electro-absorption modulator fed by two signals and controlled electrically at a high-frequency. However, the two comparison signals of the phase-locked loop are not evaluated by differentiation. Hence, pattern changes and, more particularly, a change in the number ratio of the transmitted zero-bits and one-bits, power fluctuations and changes in the signal-to-noise-ratio in the transmitted data signal result directly in an undesirable shift of the phase of the recovered clock signal relative to the data stream. Moreover, it is known from publication IV by E. S. Awad et al.: “All-optical timing extraction with simultaneous Optical demultiplexing using time-dependent loss saturation in Electro-Absorption Modulator” (CLEO 2002, Long Beach, Paper CPDB 9-1) to provide in a phase-locked loop an electro-absorption modulator bidirectionally fed by two signals, viz.: the data signal and the recovered and fed-back clock signal, which is, however, controlled optically (rather than electrically at high-frequency). This, however, makes necessary a high input power of the data signal. In the optical control, a powerful pulse generates a rapid increase of the transmission in the electro-absorption modulator which is followed by a substantially longer recovery period. However, it is the long recovery period which results in very wide switching windows (see FIG. 2b in the publication) (in that case more than 20 ps). This renders clock recovery at high data rates very difficult. Electrically controlling the phase-locked loop by a high-frequency pulse, for instance an RF signal as provided for in the case of the phase-locked loop for clock recovery in accordance with the invention, makes possible the generation of substantially narrower switching windows so that substantially higher data rates can be processed. While in the known electro-absorption modulator the data and control pulse signals influence each other, the reaction to power fluctuations in the received data signal is substantially more sensitive. In particular, changes in the signal-to-noise-ratio in the data signal lead to an unintentional phase shift in the recovered clock pulse. Moreover, no additional signal based on the data signal and not fed back is being conducted through the phase comparator.

It is also possible, in accordance with a further embodiment of the invention, to structure the optical phase comparator as an interferometric switch of SLALOM configuration (Semiconductor Laser Amplifier in Loop Mirror—SLALOM). It is also possible to use other interferometric switches, for instance a Mach-Zehnder interferometer, as phase comparators. A SLALOM configuration for clock recovery by a phase-locked loop of the kind under consideration is known in principle from publication I referred to supra. The clock signal of the voltage-controlled oscillator is derived by a so-called “balanced detection” by forming a weighted difference of the optical powers ahead of and behind the optical switch. This counteracts fluctuations in the average power of the data signal, however, pattern dependance is immanent. The operating point of the phase-locked loop is set by carrying out controls at an edge of the switching window. Increasing the data rate in this known clock recovery results in a reduced switching window contrast and, hence, to a clock recovery of reduced stability. Thus, it is known from tests conducted by applicants that the range of stability of the known structure at a data rate of 160 Gbit/s is so low that latching of the phase-locked loop can be achieved for a short duration only and that, therefore, it is relatively unstable.

The control action of the phase-locked loop may be decisively improved in the preferred realization with a SLALOM configuration by generating from the data stream from the phase-locked loop two comparison signals which are polarized vertically relative to each other and the phase of which is shifted appropriately. Such an arrangement is also suitable for non-interferometric optical switches. Advantageously, the phase delay element connected upstream of the optical switch may be a double-refractive optical fiber since at a suitable setting of the polarization ahead of this fiber (45° relative to the main axes of the double-refractive optical fiber) the data signal is divided into two polarized and phase shifted data and output signals disposed vertically relative to each other. The size of the phase shift at a given birefringent fiber is determined by the length of the fiber. Following difference formation of the two comparison signals a control signal results of about twice the power compared to the conventional method. Depending upon the set delay (differential group delay DGD), there also results a delay of the capture and holding range of the phase-locked loop, an improved signal-to-noise-ratio and a substantial independence of the occurring bit pattern. Fluctuations of intensity within the received data signal and between the data signals of different channels also exert but a small effect upon the stability of clock recovery. The input data signal may be varied over more than 6 dB without disengagement of the phase-locked loop. Compared to the substantially polarization-independent phase-locked loop provided with an electro-absorbent modulator the phase-locked loop, care must be taken, however, in respect of the data polarization in the phase-locked loop with an interferometric switch. Since the SLALOM configuration is relatively insensitive to intensity fluctuations, commercial polarization controllers may be used. They are actuators for defined setting and, hence, control of the phase shift.

In general, the phase-locked loop of the invention may, in accordance with a further embodiment of the invention, be advantageously improved by photo diodes functioning as transducers for opto-electrically transducing the two output signals of the phase-locked loop. These are inexpensive commercial components which contribute to the cost efficiency of the claimed circuit arrangement. Depending upon the arrangement, a narrow detection band width will suffice. In accordance with a further embodiment of the invention the transducer for opto-electrically transducing the clock signal may advantageously be a tuneable mode-locked laser (TMLL) and a fiber amplifier (FA) or erbium-doped fiber amplifier (EDFA). Such an electro-optic transducer is known, for instance, from publication I discussed supra and makes possible good and stable transducing even at high temperatures.

### DESCRIPTION OF THE SEVERAL DRAWINGS

The novel features which are considered to be characteristic of the invention are set forth with particularity in the appended claims. The invention itself, however, in respect of its structure, construction and lay-out, as well as manufacturing techniques, together with other objects and advantages thereof, will be best understood from the following description when read with reference to the drawings, in which:

FIG. 1 shows a general phase-locked loop in accordance with the invention;

FIG. 2 depicts a phase-locked loop in accordance with the invention with an EAM;

FIG. 3 is a signal diagram relating to the phase-locked loop with EAM;

FIG. 4 is an eye diagram and the recovered clock signal following electro-optical transducing in the phase-locked loop with EAM;

FIG. 5 is a bit error diagram relating to the phase-locked loop with EAM;

FIG. 6 is a phase-locked loop in accordance with the invention with an interferometric switch in SLALOM configuration;

FIG. 7 is a signal diagram relating to the phase-locked loop with SLALOM; and

FIG. 8 depicts a comparison of the phase-locked loop with EAM with the prior art.

### DETAILED DESCRIPTION OF THE PREFERRED EMBODIMENTS

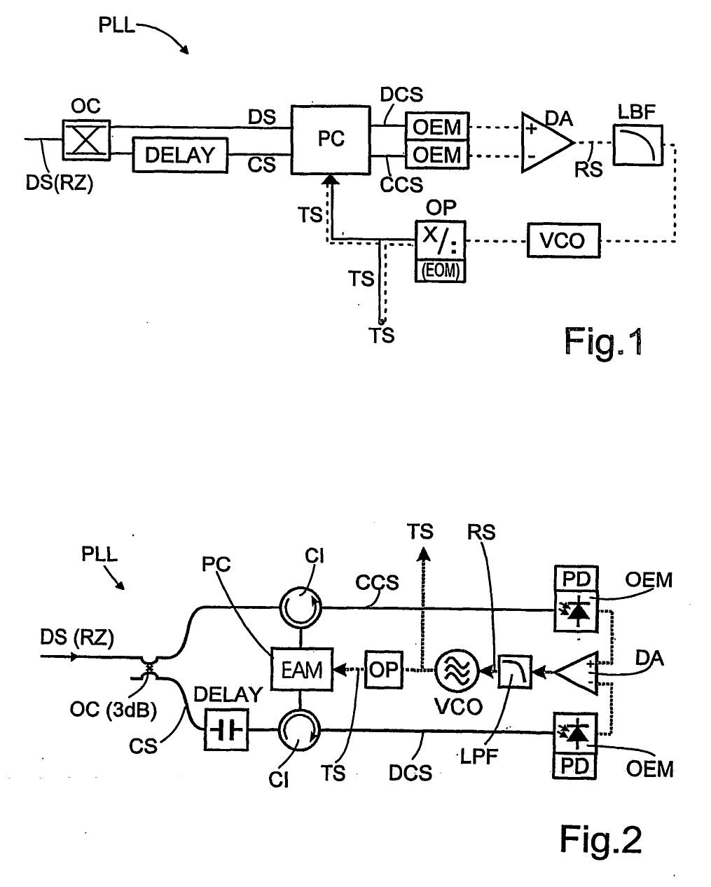

FIG. 1 schematically depicts an opto-electric phase-locked loop PLL by means of which the clock signal TS of an optical time division multiplexed (OTDM) data signal DS transmitted at a high frequency with return-to-zero RZ data pulses can be safely recovered. The optical paths are shown in solid lines, the electrical paths are shown in dashed lines. For the clock recovery, an output signal CS is initially generated by way of an optical extractor OC. This is fed through a phase delay element DELAY and is thus shifted in its phase relative to the data signal DS. Alternatively, the data signal DS may be fed through the phase delay element DELAY since it is only the relative phase shift between the two signals DS, CS which matters. The height and-shape of the switching window may be affected by the size set for the phase shift, preferably between ⅙ and ½ of the data signal period. The data signal DS as well as the output signal CS are fed unidirectionally or counterdirectionally to a phase comparator PC. Alternatively, each signal may be fed to its own phase comparator. The optical comparison signals DCS and CCS formed n the phase comparator PC by comparison with the recovered clock signal TS are fed to opto-electric transducers OEM and transformed into electrical signals. These are applied to the two inputs of a differential amplifier DA. The resultant control signal RS will be present at the output of the amplifier. The control signal RS is conducted by way of a low pass filter LPF to a voltage-controlled oscillator VCO which makes available the recovered clock signal TS (electrically or optically transformed). In this manner, the phase-locked loop PLL becomes latched. The recovered clock signal TS may be divided or multiplied by an operator element OP in order optimally to adjust it to the data signal DS.

FIG. 2 depicts a phase comparator PC structured as an electro-absorption modulator EAM (identical reference characters not mentioned here can be taken from FIG. 1). The data signal DS and the output signal CS are fed to the electro-absorption modulator EAM in opposite directions by way of circulators CI, traverse it bidirectionally and leave the electro-absorption modulator EAM again by way of the respective other circulator CI. In the ultra-fast electro-absorption modulator EAM, the input signals DS, CS are correlated with the recovered clock signal TS and the difference frequencies are formed. The optical extractor OC is structured as a 3 dB-extractor which evenly divides to signal power. In the selected embodiment, the opto-electric transducers OEM are structured as slow photo-diodes PD (for instance 100 MHz band width). The band width of the low-pass filter LPF is 50 MHz, for instance.

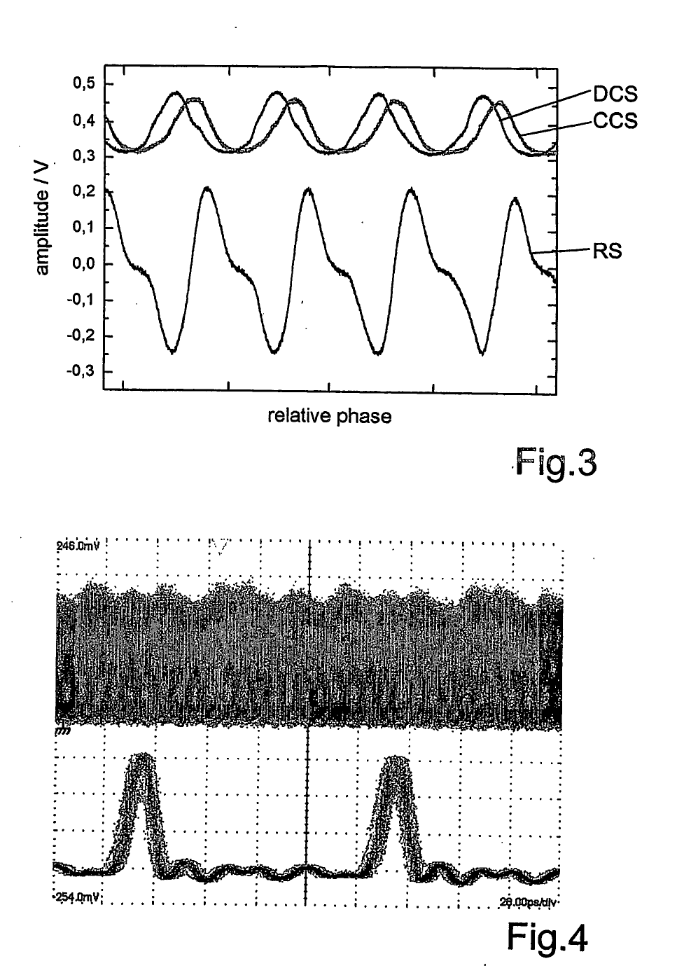

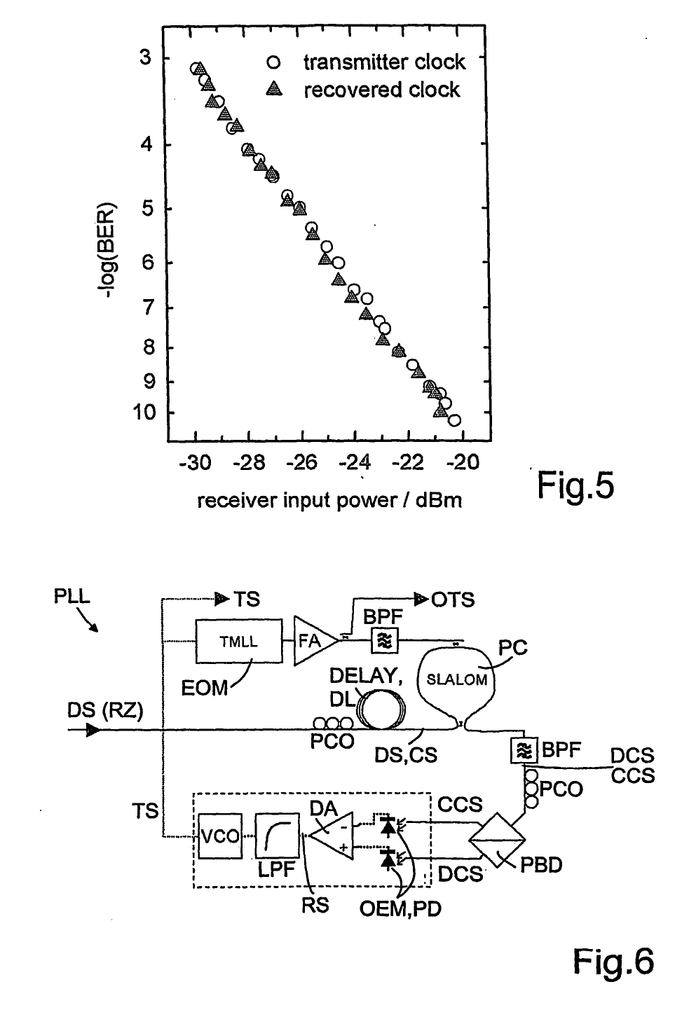

In its upper section the diagram according to FIG. 3 depicts the switched output powers (amplitude) of the electro-absorption modulators EAM over the relative phase. These are the comparative signals in both directions for a high-frequency clock pulse of 40 GHZ (RF signal). Because of the time delay element DELAY in one of the two signal paths ahead of the electro-absorption modulators EAM the two comparative signals DCS, CCS are adjustably phase-shifted. In this manner the stability and the shape of the control signal RS of the differential amplifier DA (switching window) may be set. The optimum delay depends upon the data rate of the received data signal DS. However, experiments have shown that upon adjustment of the delay to a data rate of 160 Gbit/s it was also possible to attain a stable latching mode at 40 Gbit/s and 80 Gbit/s without any need for post-adjustment of the delay. In its lower section of the diagram there is shown the issued control signal RS of the differential amplifier DA. A large linear section of the curve is seen as the optimum operating range of the voltage-controlled oscillator VCO. FIG. 4 depicts the RZ eye diagram (amplitude over time) of the data signal of 160 Gbit/s and of the recovered clock signal of 10 GHZ. Measurements were taken with an electrical sampling oscilloscope of a band width of 50 GHZ and triggering with the 10 GHZ signal of the transmitter. No channel transfers occurred for several hours. Time jitter of only 120 fs or less could be observed. The bit error rates of the receiver controlled by the 10 GHZ signal of the transmitter (circles, transmitter clock) and, alternatively, by the recovered clock signal (triangles, recovered clock) are shown in the diagram of FIG. 5 (bit error rate BER negative logarithmically over the input power of the receiver—receiver input power in dBm). The two curves showed good conformity. Hence, the signal recovery in accordance with the invention does not result in a deterioration at the receiver.

FIG. 6 depicts an embodiment of a phase comparator PC in the phase-locked loop PLL in accordance with the invention structured as a fast interferometric switch IS of SLALOM configuration. Again, the optical signal paths are shown in solid lines, the electrical ones are shown in broken lines. In this embodiment the extracted signal CS is polarized vertically relative to the data signal DS. At the same time, the birefringent light guide fiber DL functions as a phase delay element DELAY. Both signals, DS, CS are coupled into the phase comparator PC in the same direction but shifted in phase and are correlated therein to the fed-back optical clock signal OTS. Comparison signals DCS, CCS are formed. For filtering out the optical clock signals, the comparison signals are fed to a polarization beam splitter PBD by way of a band-pass filter BPF which optically separates the comparison signals DCS, CCS and feeds them to the differential amplifier DA by way of optical transducers OEM (in this case photo diodes PD). A polarization adjuster PCO serves to set the intensity of the signals DS and CS and to polarize the two comparison signals DCS and CCS. The electrical control signal RS of the differential amplifier DA is fed in a manner known per se to the voltage-controlled oscillator VCO by way of a low-pass filter LPF. On the one hand, the oscillator VCO outputs the recovered clock signal TS electrically and, on the other hand, it feeds it through an electro-optical transducer OEM and a further band-pass filter BPF as a high-frequency optical clock signal OTS to the phase comparator PC thereby closing the phase-locked loop PLL. In the selected embodiment, the electro-optical transducer OEM is formed as an tuneable ultra-fast mode-locked laser TMLL with a fiber amplifier FA at the output thereof. The operation of the interferometric switch IS is analogous to the operation of the electro-absorption modulator EAM of FIG. 2. However, the modulator EAM is electrically controlled at a high frequency whereas the interferometric switch IS is controlled optically at a high frequency. However, in both instances two comparison signals DCS, CCS are generated into which the recovered clock signal is coupled, and both comparison signals DCS, CCS are fed to the differential amplifier DA. Because of the approximated differentiation, both embodiments achieve an especially constant locking operation of the phase-locked loop PLL with a large linear operational range. The achieved quality was comparable to that of FIG. 5 (BER).

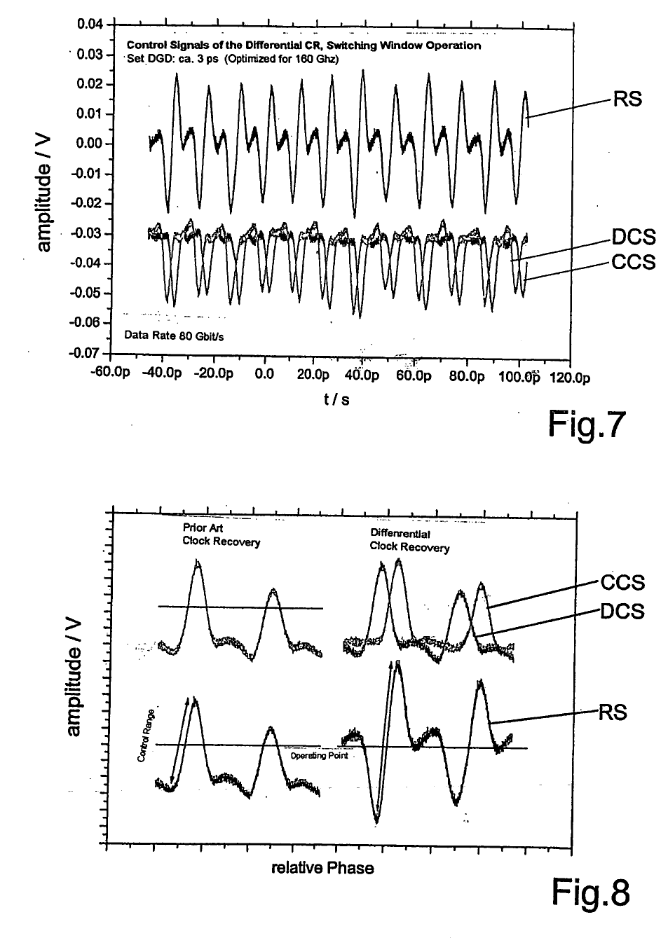

FIG. 7 shows the signal diagram of the phase-locked loop PLL with a phase comparator PC in SLALOM configuration. The switching windows (the orientation of the switching windows is inverted relative to the presentation of FIG. 3) are shown at the lower portion of the diagram, and the resulting control signal RS is shown in the upper portion. The switching windows generated by the interferometric switch are of shorter duration than those of the electro-absorbing modulator EAM shown in FIG. 3. This is primarily due to the different control of the two switching elements. In principle it is possible with the electro-absorption modulator EAM to generate switching windows equally short as those of the interferometric switch. Using short switching windows is particularly necessary at high data rates. The power of the control signal RS at a given data rate depends upon the chronological shift of the two comparison signals DCS, CCS. A shift of half a data period yields a maximum control signal RS (twice as powerful than hitherto). In switching window operation, this corresponds to anti-phase shifting windows. The phase of the two comparison signals DCS, CCS is then shifted such that they correspond to scanning of the opposite edges of a switching window. At this setting, the lock-in and holding range of the phase-lock loop PLL is greatest.

The operation of the phase comparator PC carried out by two signals shifted relative to each other makes possible a differentiated phase evaluation. The operation will be exemplarily explained on the basis of the diagram of FIG. 8 for a known simple pattern (on the left) and for a differential pattern in accordance with the invention (on the right). Switching windows are shown at the upper portion of the diagram which were recorded by the photo detectors PD of the clock-recovery electronics; the further processed signal which is used to control the voltage-controlled oscillator VCO is shown at the lower portion. The switching windows are measured by the phase comparator PC (in this case an electro-absorption modulator EAM) being controlled electrically at a frequency which is slightly shifted relative to the frequency relative to the frequency of the optical data signal DS. The resulting comparison signal DCS or CCS, as the case may be, repeats at the difference frequency, and the abscissa scales with the phase difference of the signals DS and TS or CS and TS received at the electro-absorption modulator EAM. In the simple pulse recovery in accordance with the prior art the working pint is set by a constant voltage obtained from the average power of the optical data signal DS. The range of control of the voltage-controlled oscillator VCO is represented by the edge of the switching window. If the power in one of the data channels is changed (for instance at OTDM), a shift of the phase of the recovered clock pulse TS will be the result. Also, the working point is then no longer positioned at the center of the range of control so that the phase-locked loop will more readily unlock. However, in the differential pulse recovery in accordance with the invention, two chronologically shifted switching windows are generated. By difference formation a control signal RS will thus result the working point of which is always in the center of the control range, regardless of the power of the data channel. The size of the control range can be optimized in the phase delay element DELAY by the optical delay set between the two signals DS, CS. In the differential pulse recovery in accordance with the invention, the dependence from power fluctuations, signal-to-noise-ratio, the shape of the pulse and the transmitted bit pattern is thus largely eliminated. Measurements have shown that the long-term stability of the pulse recovery was significantly improved.

What is claimed is:

1. An opto-electric phase-locked loop for the recovery at a receiver of a clock signal of a high-frequency data signal with zero return transmitted in a digital optical transmission system with an optically switching phase comparator, an electronic differential amplifier and a voltage controlled oscillator, whereby a comparison signal formed in the phase comparator by comparing the data signal and the recovered clock signal, and a signal extracted from the data signal are fed to the two inputs of the differential amplifier, and an electric control signal generated at the output of the differential amplifier is fed through a low-pass filter to the oscillator the controlled frequency signal of which is issued as the recovered clock signal, characterized by, prior to the one or the additional phase comparator (PC), the extracted signal is fed to an optical phase delay element (DELAY) and then through the one or through the additional phase comparator (PC) where it is superimposed by the recovered and fed-back clock signal (TS), and by the two phase-shifted comparison signals (DCS, CCS) formed in the one or more phase comparators (PC) being fed to the two inputs of the differential amplifier (DA).

2. The circuit arrangement of claim 1,
characterized by the fact that
the phase delay element (DELAY) is structured as a polarization-independent component with two wavelengths of different lengths or as a polarization-independent component with a birefringent light guide fiber (DL) or as a polarizing beam splitter and a polarization beam junction each with an optical connection for each polarization direction and an optical delay in a connecting path.

3. The circuit arrangement of claim 1,
characterized by the fact that
the phase delay element (DELAY) generates a chronological phase shift of ⅙ to ½ of the period of the data signal (DS) between the two comparison signals (DCS, CCS).

4. The circuit of one of claims 1,
characterized by the fact that
in the case of a common phase comparator (PC) it is operated bidirectionally with counter-propagating polarization-independent comparison signals (DCS, CCS) or with uni-directional differently polarized comparison signals (DCS, CCS), whereby the the unidirectional comparison signals (DCS, CCS) are optically separated by a polarization beam splitter (PBD) downstream from the phase comparator (PC).

5. The circuit arrangement of one of claims 1,
characterized by the fact that
the extracted signal (CS) is derived from the data signal (DS) by way of an optical coupler (OC), in particular a 3-dB-coupler.

6. The circuit arrangement of one of claims 1,
characterized by the fact that
That the phase comparator (PC) is structured as an electrically controlled electro-absorption modulator (EAM).

7. The circuit arrangement of claim 6,
characterized by the fact that
The signal is coupled into the electro-absorption modulator (EAM) by way of two circulators (CI) or 3dB-couplers.

8. The circuit arrangement of one of claims 6,
characterized by the fact that
the electro-absorption modulator (EAM) is electrically controlled by an RF signal.

9. The circuit arrangement of one of claims 1,
characterized by the fact that
the phase comparator (PC) is structured as an interferometric switch (IS) of SLALOM configuration.

10. The circuit arrangement of one of claims 1,
characterized by the fact that
that the opto-electric transducers (OEM) are structured as slow photo diodes (PD) and that the electro-optic transducer (EOM) is structured as a tuneable mode-locked laser (TMLL).
